(19) United States
(12) Patent Application Publication
(10) Pub. No.: US 2009/0034469 A1
(43) Pub. Date: Feb. 5, 2009

(54) METHOD AND SYSTEM FOR SEARCHING TARGET CELL BY USING MULTIMODE-MULTIBAND TERMINAL IN MOBILE COMMUNICATION ENVIRONMENT

(75) Inventor: Younglak Kim, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 11/573,984

(22) PCT Filed: Aug. 18, 2005
(86) PCT No.: PCT/KR05/02713

§ 371 Date: Feb. 20, 2007

(30) Foreign Application Priority Data
Aug. 20, 2004 (KR) 10-2004-0066097

(51) Int. Cl. H04W 36/00

(52) U.S. Cl. 370/331

(57) ABSTRACT

Disclosed is a method for searching for a target cell by using a multimode-multiband terminal in mobile communication environments, in which a mobile communication system improves a handover success rate and communication quality by reducing time required for searching for the target cell, the mobile communication system including a CDMA-2000 system and a WCDMA system, the CDMA-2000 system including a base-station transmission system and a base station controller and providing a CDMA-2000 service to a terminal requesting access, the WCDMA system including an RTS and an RNC and providing a WCDMA service to the terminal requesting the access. The method including: (a) receiving WCDMA signals transmitted from the WCDMA system through a WCDMA modem in order to measure an E_{c}/Iₒ value; (b) turning on a CDMA-2000 modem according to a result of step (a) and entering an idle state; (c) monitoring a handover-target cell; (d) transmitting a handover request to the WCDMA system; (e) receiving a handover command from the WCDMA system; and (f) turning off the WCDMA modem and switching a communication link to the CDMA-2000 system through the CDMA-2000 modem.

### TECHNICAL FIELD

The present invention relates to a method and a system for searching for a target cell by using a multimode-multiband terminal in mobile communication environments. More particularly, the present invention relates to a method and a system for searching for a target cell by using a multimode-multiband terminal in mobile communication environments for preventing the deterioration of communication quality due to a handover delay by reducing time required for searching for the target cell when handover of the multimode-multiband terminal is performed in a mobile communication system including a CDMA-2000 system and a WCDMA system.

### BACKGROUND ART

Starting from the 1 G voice-based mobile communication service of low quality provided from an analog cellular Advanced Mobile Phone Service (AMPS, which has been serviced since the latter half of 1980's, mobile communication services are continuously evolving. In the 2 G mobile communication service, improved voice communication and low speed (14.4 Kbps) data service have been available, which have been provided from a Global System for Mobile (GSM), Code Division Multiple Access (hereinafter, referred to as CDMA), Time Division Multiple Access (TDMA), etc., of a digital cellular scheme. In the 2.5 G mobile communication service, as a frequency of GHz has been ensured and a Personal Communication Service (PCS) available throughout the world has been developed, improved voice communication and low speed (144 Kbps) data service have also become available.

A mobile communication network for mobile communication services up to the 2.5 G includes various communication equipments such as user equipments, base-station transmission systems, base station controllers, mobile communication switching centers, Home Location Registers (HLRs) and Visitor Location Registers (VLRs).

The 3 G mobile communication service has been provided by a wideband CDMA (hereinafter, referred to as WCDMA) system of an asynchronous scheme proposed by a 3^{rd} Generation Partnership Project (hereinafter, referred to as 3GPP) and a CDMA-2000 system of a synchronous scheme proposed by a 3GPP2. The WCDMA system has adopted a wireless protocol recommended by an IMT-2000. Accordingly, many communication service providers around the world have provided the 3 G mobile communication service or have prepared the start of the 3 G mobile communication service.

Because the WCDMA system has not only superior communication quality, but also uses a spread spectrum scheme, it is appropriate for the transmission of large quantity of data. A WCDMA communication scheme has adopted 32 Kbps Adaptive Differential Pulse Code Modulation (ADPCM) for a voice coding, and supports high mobility, so that a user can communicate with others even when the user is moving at a speed of about 100 km/h. A WCDMA communication scheme has been adopted by most countries, and the 3GPP including many organizations in Korea, Europe, Japan, USA, China, etc., has continuously developed a technical specification for WCDMA.

In the meantime, because of the advantages of the WCDMA system as described above, a country, such as Korea, USA, China, etc., providing a basic CDMA-2000 service has constructed the WCDMA system and has started to provide a WCDMA service.

FIG. 1 is a diagram schematically illustrating a mobile communication system for providing a WCDMA service in communication environments including a basic CDMA-2000 system.

The WCDMA service is provided to some areas within a CDMA-2000 area 120 to which a CDMA-2000 service is provided. Hereinafter, it is assumed that areas to which the WCDMA service is provided within the CDMA-2000 area 120 are referred to as overlay areas 130 and 140. That is, a mobile communication subscriber can selectively receive a desired one of the CDMA-2000 service and the WCDMA service in the overlay areas 130 and 140. In order to use the CDMA-2000 service and the WCDMA service, a multimode-multiband terminal 110 is required.

The multimode-multiband terminal 110 is a mobile communication terminal capable of supporting both a multimode and a multiband. The multimode includes a synchronous mode, an asynchronous mode, etc., while the multiband includes frequency bands of the 2 G mobile communication service using a frequency band of 800 MHz, the 2.5 G mobile communication service using a frequency band of 1.8 GHz, the 3 G mobile communication service using a frequency band of about 2 GHz, and the 4 G mobile communication service which will be provided in the future. The multimode-multiband terminal 110 operates in a WCDMA mode or a CDMA-2000 mode according to types of communication services provided to an area including the multimode-multiband terminal 110.

When a mobile communication subscriber deviates from the overlay area 130 and moves into the CDMA-2000 area 120, the multimode-multiband terminal 110 performs handover. The handover represents a communication link is maintained between the multimode-multiband terminal 110 and a mobile communication system even though a service area changes.

The multimode-multiband terminal 110 forms a communication link with a WCDMA system in the overlay area 130. However, when the mobile communication subscriber enters the CDMA-2000 service area 120, the multimode-multiband terminal 110 switches the communication link to a CDMA-2000 system through switching between a WCDMA modem and a CDMA-2000 modem.

However, in the conventional handover process, the multimode-multiband terminal 110 operates the installed CDMA-2000 modem so as to perform an initialization operation, enters an idle state, and then searches for a target cell in the CDMA-2000 service area 120, in which communication link is to be formed, in the idle state. In the idle state, the CDMA-2000 modem must perform a process for receiving various overhead messages from the CDMA-2000 system, registering position information, etc. Further, because it takes about 4˜5 seconds to perform the process for receiving the overhead messages, registering the position information, etc., delay time inevitably occurs in searching for the target cell for which handover is to be performed. The delay time occurring in searching for the target cell reduces a handover success rate, so that it is difficult to maintain the communication link. Therefore, communication interruption may occur.

### DISCLOSURE OF THE INVENTION

Therefore, the present invention has been made in view of the above-mentioned problems, and it is an object of the present invention to provide a method and a system for searching for a handover-target cell by using a multimode-multiband terminal in mobile communication environments in which delay time required for searching for the handover-target cell can be reduced and a handover success rate can be improved by causing a CDMA-2000 modem having completed an initialization operation both to omit a process for receiving an overhead message from a CDMA-2000 system, registering position information, etc., and to search for the handover-target cell in a process of receiving a mobile communication service by means of the multimode-multiband terminal.

According to one aspect of the present invention, there is provided a method for searching for a target cell by using a multimode-multiband terminal in mobile communication environments, in which a mobile communication system improves a handover success rate and communication quality by reducing time required for searching for the target cell, the mobile communication system including a CDMA-2000 system and a WCDMA system, the CDMA-2000 system including a base-station transmission system and a base station controller and providing a CDMA-2000 service to a terminal requesting access, the WCDMA system including a Radio Transceiver Sub-system (RTS) and a Radio Network Controller (RNC) and providing a WCDMA service to the terminal requesting the access, the method including the steps of: (a) receiving WCDMA signals transmitted from the WCDMA system through a WCDMA modem in order to measure an Energy of Carrier/Interference of Others (E_{c}/Iₒ) value; (b) turning on a CDMA-2000 modem according to a result of step (a) and entering an idle state; (c) monitoring a handover-target cell; (d) transmitting a handover request to the WCDMA system; (e) receiving a handover command from the WCDMA system; and (f) turning off the WCDMA modem and switching a communication link to the CDMA-2000 system through the CDMA-2000 modem.

According to another aspect of the present invention, there is provided a multimode-multiband terminal for improving a handover success rate and communication quality by reducing time required for searching for a target cell in a mobile communication system, the mobile communication system including a CDMA-2000 system and a WCDMA system, the CDMA-2000 system including a base-station transmission system and a base station controller and providing a CDMA-2000 service to a terminal requesting access, the WCDMA system including a Radio Transceiver Sub-system (RTS) and a Radio Network Controller (RNC) and providing a WCDMA service to the terminal requesting the access, the multimode-multiband terminal including: an antenna for transmitting/receiving Radio Frequency (RF) signals through an air interface; an RF transmission/reception unit for transmitting/receiving and modulating/demodulating the RF signals; a CDMA-2000 filter for extracting desired CDMA signals from the RF signals of a CDMA-2000 band from the RF transmission/reception unit; a CDMA-2000 modem for performing a call processing for the CDMA signals according to protocols defined in a CDMA-2000 standard; a WCDMA filter for extracting desired WCDMA signals from the RF signals of a WCDMA band from the RF transmission/reception unit; a WCDMA modem for performing a call processing for the WCDMA signals according to protocols defined in a WCDMA standard; a controller for selecting either a WCDMA mode or a CDMA-2000 mode and controlling the multimode-multiband terminal to operate in the selected mode; and a program storage unit for storing a realtime processing Operating System (OS) and a target cell monitoring program.

According to further another aspect of the present invention, there is provided a mobile communication system for providing a multimode-multiband terminal with a CDMA-2000 service and a WCDMA service and improving a handover success rate and communication quality by reducing time required for searching for a target cell, the mobile communication system including: a Radio Access Network (RAN) for providing the CDMA-2000 service through a traffic channel of signal channels, the RAN being disposed in each cell; a WCDMA Radio Access Network (W-RAN) for providing the WCDMA service through the traffic channel of the signal channels, the W-RAN being disposed in each cell; and a mobile communication switching center for performing functions of processing basic and supplementary services, processing subscriber's incoming and outgoing calls, processing position information registration and handover procedures, and inter-working with other networks.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a diagram schematically illustrating a mobile communication system for providing a WCDMA service in communication environments including a basic CDMA-2000 system;

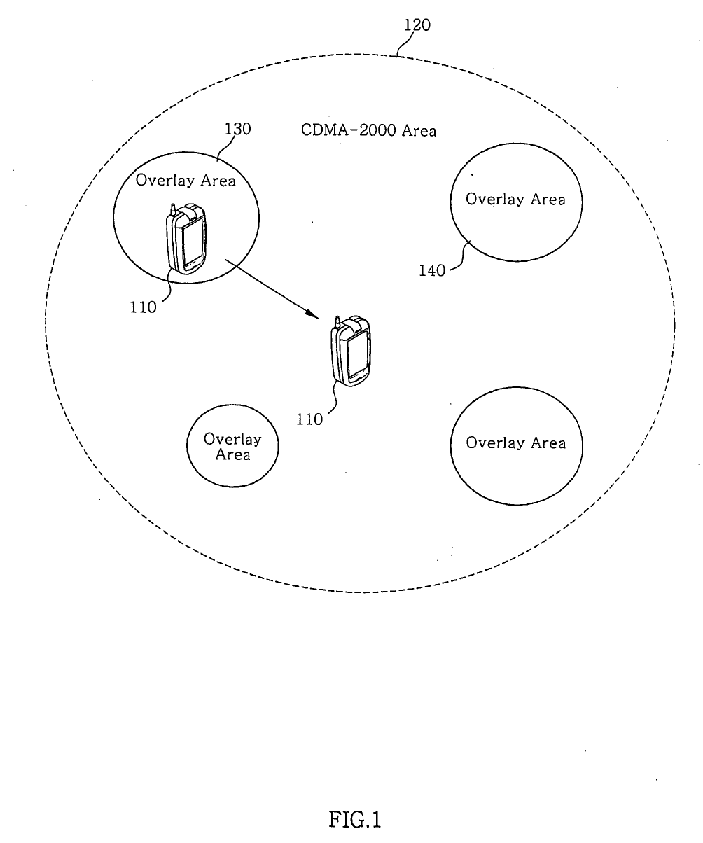

FIG. 2 is a block diagram schematically illustrating the construction of a multimode-multiband terminal according to a preferred embodiment of the present invention;

FIG. 3 is a flow diagram illustrating the operation process of a multimode-multiband terminal according to a preferred embodiment of the present invention;

FIG. 4 is a block diagram schematically illustrating the construction of a mobile communication system which forms a communication link with a multimode-multiband terminal according to a preferred embodiment of the present invention; and

FIG. 5 is a ladder diagram illustrating the handover process of a multimode-multiband terminal according to a preferred embodiment of the present invention.

### BEST MODE FOR CARRYING OUT THE INVENTION

Reference will now be made in detail to the preferred embodiment of the present invention. The same reference numerals are used to designate the same elements as those shown in other drawings. In the following description of the present invention, a detailed description of known configurations and functions incorporated herein will be omitted when it may make the subject matter of the present invention unclear.

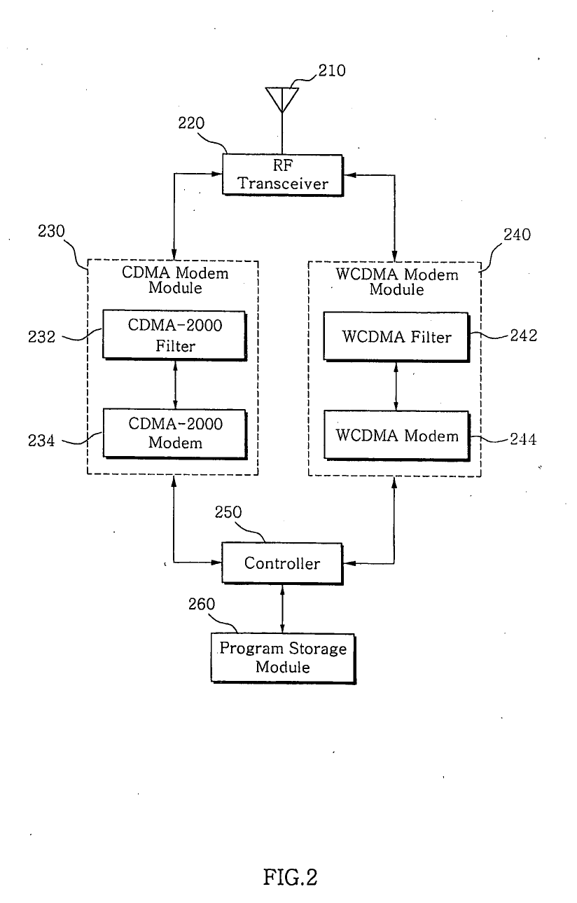

FIG. 2 is a block diagram schematically illustrating the construction of a multimode-multiband terminal according to a preferred embodiment of the present invention.

The multimode-multiband terminal includes an antenna 210, a Radio Frequency (hereinafter, referred to as RF) transmission/reception unit 220, a Code Division Multiple Access (hereinafter, referred to as CDMA) modem unit 230, a wideband CDMA (hereinafter, referred to as WCDMA) modem unit 240, a controller 250, a program storage unit 260, etc.

The antenna 210 receives RF signals transmitted from a radio base station in an adjacent area, transfers the received RF signals to the RF transmission/reception unit 220, receives modulated RF signals from the RF transmission/reception unit 220, and transmits the modulated RF signals to the air.

The RF transmission/reception unit 220 demodulates the RF signals received from the antenna 210, and transfers the demodulated RF signals to a CDMA-2000 filter 232 of the CDMA modem unit 230, or to a WCDMA filter 242 of the WCDMA modem unit 240. Of course, the RF transmission/reception unit 220 performs functions of receiving transmission data from the CDMA modem unit 230 or the WCDMA modem unit 240, modulating the received data into RF signals, and transmitting the modulated RF signals to the air via the antenna 210.

The CDMA modem 230 includes the CDMA-2000 filter 232 and a CDMA-2000 modem 234 for a CDMA-2000 service. The CDMA-2000 filter 232 extracts digital signals of a CDMA-2000 band from the RF signals demodulated by the RF transmission/reception unit 220, according to an operation mode of the multimode-multiband terminal, and transfers the extracted digital signals to the CDMA-2000 modem 234. The CDMA-2000 modem 234 performs a call processing for the digital signals of the CDMA-2000 band transferred from the CDMA-2000 filter 232 according to the protocols defined in the CDMA-2000 standard.

The WCDMA modem 240 includes the WCDMA filter 242 and a WCDMA modem 244 for a WCDMA service. The WCDMA filter 242 extracts digital signals of a WCDMA band from the RF signals demodulated by the RF transmission/reception unit 220, according to an operation mode of the multimode-multiband terminal, and transfers the extracted digital signals to the WCDMA modem 244. The WCDMA modem 244 performs a call processing for the digital signals of the WCDMA band transferred from the WCDMA filter 242 according to the protocols defined in the WCDMA standard.

The controller 250 controls the general operation of the multimode-multiband terminal, and controls the multimode-multiband terminal to operate in either a WCDMA mode or a CDMA-2000 mode based on received RF signals, i.e., WCDMA signals or CDMA-2000 signals. When a specific operation mode is selected, the controller 250 transmits control signals to the CDMA modem unit 230 or the WCDMA modem unit 240, thereby controlling one of the CDMA modem unit 230 and the WCDMA modem unit 240 to operate.

The program storage unit 260 includes an Electrically Erasable Programmable Read-Only Memory (EEPROM), a flash memory, a Random Access Memory (hereinafter, referred to as RAM), etc., which are installed on the internal circuit board of the multimode-multiband terminal. The flash memory stores a realtime processing Operating System (OS), a target cell monitoring program, etc., and these programs are loaded to the RAM for execution.

The target cell monitoring program represents software for controlling a process including reception of various overhead messages from the CDMA-2000 system, position information registration, etc., not to be performed after an initialization operation of the CDMA-2000 modem 234 ends, computing an Energy of Carrier/Interference of Others (E_{c}/Iₒ) value by means of CDMA-2000 pilot signals received through the antenna 210 and the RF transmission/reception unit 220, and transmitting a handover request to a radio base station having transmitted pilot signals of a large E_{c}/Iₒ value.

The E_{c}/Iₒ represents a ratio of the intensity of pilot signals with respect to the amplitude of all received noise, which is used as a unit representing the quality of the pilot signals. In general, the E_{c}/Iₒ has a value of about −1˜−2 dB in a region having small traffic and no overlap of electric waves, the E_{c}/Iₒ has a value of about −6˜−22 dB in a region having large traffic and overlap of electric waves, and the E_{c}/Iₒ has a value of about −10 dB in the higher floors of high-rise buildings having overlap of electric waves. When the E_{c}/Iₒ has a value of about −10˜−14 dB, sound interruption may start to occur. Further, when the E_{c}/Iₒ has a value smaller than −14 dB, a communication interruption may occur.

According to the present invention, the controller 250 executes the target cell monitoring program stored in the program storage unit 260, and controls monitoring of a handover-target cell through the executed target cell monitoring program after the initialization operation of the CDMA-2000 modem 234 ends.

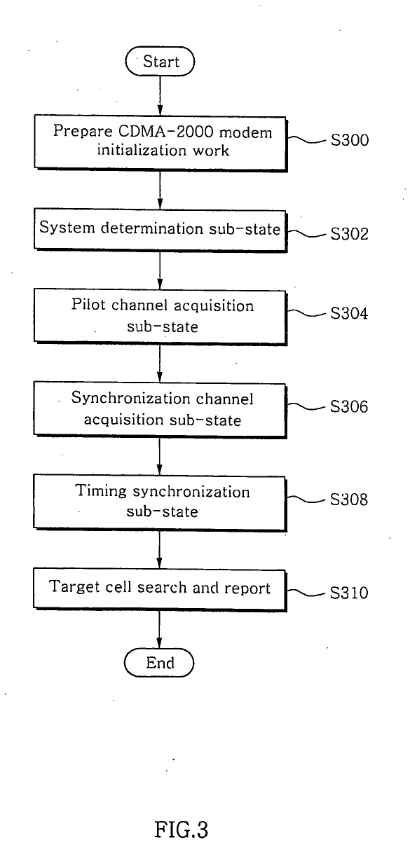

FIG. 3 is a flow diagram illustrating the operation process of the multimode-multiband terminal according to a preferred embodiment of the present invention.

If a mobile communication subscriber moves into a CDMA-2000 area after initially forming a communication link in an overlay area, the multimode-multiband terminal performs handover.

That is, the controller 250 of the multimode-multiband terminal executes the target cell monitoring program stored in the program storage unit 260, generates an on-parameter, and transfers the generated on-parameter to the CDMA modem unit 230 (S300). The CDMA modem unit 230 having received the on-parameter performs an initialization operation.

The controller 250 applies power to the CDMA-2000 modem 234, and the turned on CDMA-2000 modem 234 performs a system determination sub-state operation for loading system information required for operating the CDMA-2000 modem 234 in the program storage unit 260 (S302).

After step 302 is performed, the CDMA-2000 modem 234 performs a pilot channel acquisition sub-state operation for receiving a pilot channel from a radio base station providing a CDMA-2000 service (S304). That is, in the pilot channel acquisition sub-state operation, the CDMA-2000 modem 234 sets a Walsh code to 0 and searches for a primary channel in order to receive the pilot channel.

After step 304 is performed, the CDMA-2000 modem 234 receives a synchronization channel from the radio base station. That is, the multimode-multiband terminal having received the synchronization channel performs a synchronization channel acquisition sub-state operation, and confirms a roaming state, system time, a long code state, etc (S306). After step 306 is performed, the CDMA-2000 modem 234 performs a timing synchronization sub-state operation for matching time between a pilot channel and the synchronization channel with time between a paging channel and a traffic channel by means of the PN offset, the system time, the long code state, etc., received from the synchronization channel (S308).

Steps 300, 302, 304, 306 and 308 correspond to the initialization operation of the multimode-multiband terminal. Accordingly, the multimode-multiband terminal having completed the initialization operation stays in an idle state in which the multimode-multiband terminal can process various services including voice communication, etc. Herein, after the conventional multimode-multiband terminal performs the operation including the reception of the overhead message from the radio base station, the position information registration of the multimode-multiband terminal, etc., the conventional multimode-multiband terminal monitors a target cell in a CDMA-2000 area, to which the communication link formed in the overlay area is handed over. That is, the multimode-multiband terminal monitors pilot signals transmitted from a plurality of radio base stations located in the CDMA-2000 area, detects a radio base station having high radio wave power, and performs handover.

However, the multimode-multiband terminal of the present invention checks an time point at which the initialization operation of the multimode-multiband terminal ends through the target cell monitoring program, and then monitors a handover-target cell without performing the process including the reception of the overhead message from the radio base station, the position information registration of the multimode-multiband terminal, etc.

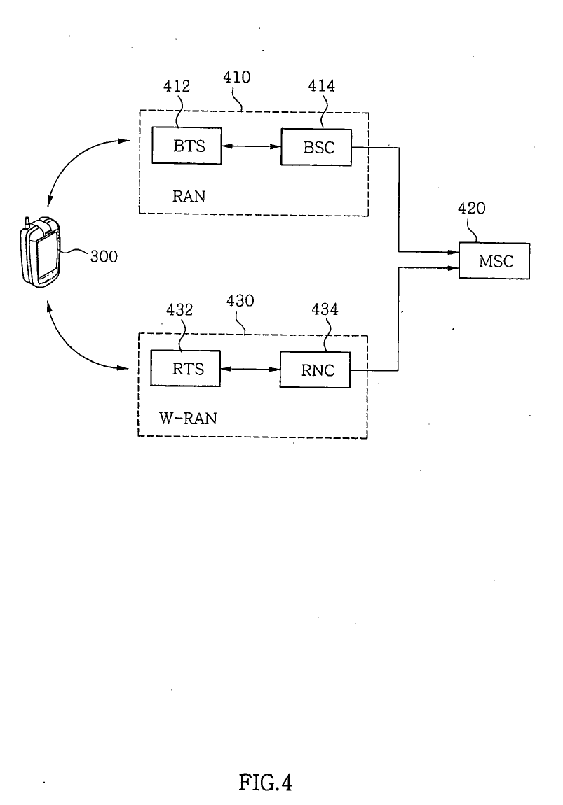

FIG. 4 is a block diagram schematically illustrating the construction of a mobile communication system that forms a communication link with the multimode-multiband terminal according to a preferred embodiment of the present invention.

The mobile communication system according to the preferred embodiment of the present invention includes the multimode-multiband terminal 400, a Radio Access Network (hereinafter, referred to as RAN) 410, a WCDMA Radio Access Network (hereinafter, referred to as W-RAN) 430, a mobile communication switching center 420, etc.

In the present invention, the multimode-multiband terminal 400 is a mobile communication terminal capable of supporting both a multimode and a multiband, which stores the target cell monitoring program. Accordingly, when the multimode-multiband terminal 400 moves from an overlay area to a CDMA-2000 area, the multimode-multiband terminal 400 turns on the CDMA-2000 modem, performs the initialization operation, and then monitors a handover-target cell in an idle state without performing the process including the reception of the overhead message from the radio base station, the position information registration, etc.

The RAN 410 is an element of the mobile communication system for supporting a CDMA-2000 service, and includes a base station transmission system 412, a base station controller 414, etc. Further, the RAN 410 is connected to the mobile communication switching center 420.

The base station transmission system 412 is disposed in each cell, which receives communication request signals from the multimode-multiband terminal 400 through a traffic channel of signal channels, and transmits the received communication request signals to the base station controller 414. Further, the base station transmission system 412 performs position information registration for understanding the position of the multimode-multiband terminal 400 existing in an area controlled by the base station transmission system 412. Furthermore, the base station transmission system 412 is a network endpoint device directly connected to the multimode-multiband terminal 400 in order to perform a baseband signal processing, a wire/wireless conversion, transmission/reception of radio signals, etc.

The base station controller 414 controls the base station transmission system 412, and performs a radio channel allocation and release function for the multimode-multiband terminal 400, a transmit power control function of the multimode-multiband terminal 400 and the base station transmission system 412, a determination function of inter-cell soft handover and inter-cell hard handover, a transcoding and vocoding function, a GPS clock distribution function, and a management and maintenance function for a base station.

Further, the base station controller 414 transmits subscriber information of the multimode-multiband terminal 400, whose position has been registered, to the mobile communication switching center 420. Furthermore, the base station controller 414 transfers the communication request signals, which have been received from the multimode-multiband terminal 400 through the base station transmission system 412, to the mobile communication switching center 420, and vice versa. That is, the base station controller 414 transfers communication request signals, which have been received from to the mobile communication switching center 420, to the multimode-multiband terminal 400 through the base station transmission system 412.

The mobile communication switching center 420 performs functions of processing basic and supplementary services, processing subscriber's incoming and outgoing calls, processing position information registration and handover procedures, inter-working with other networks, etc. The mobile communication switching center 420 in an IS-95A/B/C system includes a sub-system such as an Access Switching Sub-system (ASS) for performing a processing function of a distributed call, an Interconnection Network Sub-system (INS) for performing a processing function of a centralized call, a Central Control Sub-system (CCS) for handling a centralized management and preservation function, and a Location Registration Sub-system (LRS) for performing a storage and management function for mobile subscriber information.

Further, the mobile communication switching center 420 for the 3 G and 4 G may include an Asynchronous Transfer Mode (ATM) switch capable of improving transmission speed and efficiency of circuit use by transmitting packets by the cell.

The W-RAN 430 is an element of the mobile communication system for supporting a WCDMA service, and includes a Radio Transceiver Sub-system (hereinafter, referred to as RTS) 432, a Radio Network Controller (hereinafter, referred to as RNC) 434, etc. Further, the W-RAN 430 is connected to the mobile communication switching center 420.

The RTS 432 includes a Base station Interconnection Sub-system (BIS), a Base Band Sub-system (BBS), an RF Sub-system, etc., performs a radio access termination function with a terminal conforming to a 3GPP radio access standard, transmits/receives voice and image data by a WCDMA scheme, and transmits/receives information with the terminal through an transmit/receive antenna.

The RNC 434 handles a management function for a radio base station and a radio controller such as a resource management, a terminal protocol matching, a base station protocol matching and control path process function, a soft handover processing, a core network protocol processing, a General Packet Radio Service (GPRS) and lur connection, a system loading, and abnormality management.

The general operation of the present invention will be described on an assumption that the multimode-multiband terminal 400 initially forms a communication link in the W-RAN 430 providing the WCDMA service. When a mobile communication subscriber operates the multimode-multiband terminal 400, the multimode-multiband terminal 400 automatically enters a reception state, and sequentially searches for 21 setup channels designated as signal channels from 333 channels (when the used bandwidth is 10 MHz). Herein, the multimode-multiband terminal 400 selects a setup channel having relatively high radio wave power from the 21 setup channels, and is tuned to the channel frequency of the selected setup channel. That is, being tuned to the setup channel having the relatively high radio wave power denotes that the multimode-multiband terminal 400 selects the nearest radio base station as a radio base station for a communication link setup, because different setup channels have been allocated to all adjacent radio base stations, respectively.

This is not a busy state. However, this state corresponds to a state in which the multimode-multiband terminal 400 can respond to a call from a radio base station at any time, that is, a state in which the multimode-multiband terminal 400 can transmit signals immediately when the subscriber attempts communication. In other words, it means a state in which the multimode-multiband terminal 400 has been ready for automatic communication regardless of the subscriber's intention.

Then, when the mobile communication subscriber moves into the RAN 410 providing the CDMA-2000 service, the multimode-multiband terminal 400 performs handover by switching the communication link formed in the WCDMA system to the CDMA-2000 system through switching between the WCDMA modem and the CDMA-2000 modem.

Consequently, the technical idea of the present invention lies in that the multimode-multiband terminal 400 monitors the handover-target cell in the idle state without performing the process including the reception of the overhead message, the position information registration, etc.

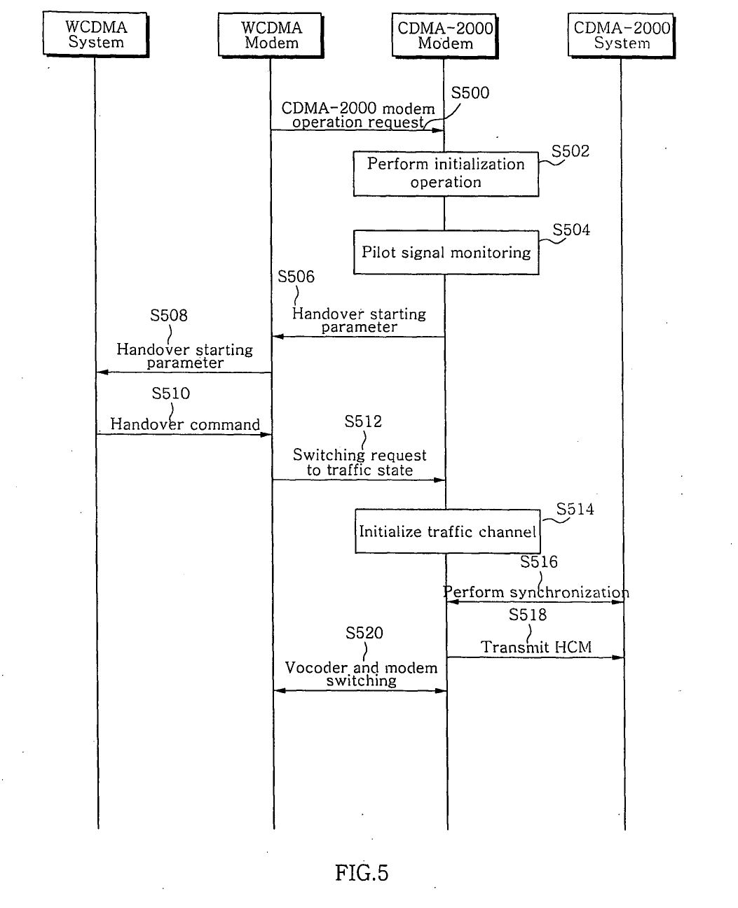

FIG. 5 is a ladder diagram illustrating a handover process of the multimode-multiband terminal according to a preferred embodiment of the present invention. in the following description, it is assumed that the multimode-multiband terminal 400 forms a communication link in the overlay area 110 and moves to the CDMA-2000 area 120.

When the multimode-multiband terminal 400 moves from the overlay area 110 to the CDMA-2000 area 120, switching between a WCDMA mode and a CDMA-2000 mode is required. That is, when the multimode-multiband terminal 400 having received the WCDMA service in the overlay area 110 moves into the CDMA-2000 area 120, the WCDMA mode is switched to the CDMA-2000 mode.

The controller 250 of the multimode-multiband terminal 400 generates an on-parameter for operating the CDMA-2000 modem 234, and transfers the generated on-parameter to the CDMA-2000 modem 234 (S500). The CDMA-2000 modem 234 having received the on-parameter performs an initialization operation (S502). The initialization operation creates environments for shifting to an idle state after setting information necessary for the operation of the multimode-multiband terminal 400. Further, the initialization operation is performed in a sequence of the system determination sub-state, the pilot channel acquisition sub-state, the synchronization channel acquisition sub-state, etc.

The CDMA-2000 modem 234 having finished the initialization operation monitors pilot signals transmitted from a plurality of radio base stations located in the CDMA-2000 area 120, and detects a radio base station having high radio wave power (S504). Herein, the multimode-multiband terminal 400 of the present invention omits the process including the reception of the overhead message from the CDMA-2000 system, the position information registration, etc., monitors the radio base station having the high radio wave power, determines a handover-target cell, generates a handover start parameter, and transmits the handover start parameter to the WCDMA modem 244 (S506).

The WCDMA modem 244 having received the handover start parameter determines to perform handover, transfers the handover start parameter to the WCDMA system, thereby requesting the handover (S508). The WCDMA system having received the handover start parameter from the multimode-multiband terminal 400 generates a handover command, transmits the generated handover command to the multimode-multiband terminal 400 (S510). The multimode-multiband terminal 400 controls the CDMA-2000 modem 234 to shift from the idle state to a traffic state (S512).

The CDMA-2000 modem 234 performs a traffic channel initialization operation for shifting to the traffic state (S514), and performs a synchronization work with a radio base station, which is intended to form a communication link, through an uplink (S516). The CDMA-2000 modem 234 having finished the synchronization with the corresponding radio base station in step 516 generates a Handover Completion Message (hereinafter, referred to as HCM) for reporting the completion of the handover, and transmits the HCM to the radio base station (S518). The multimode-multiband terminal 400 having finished the synchronization with the CDMA-2000 system turns off the WCDMA modem 244, and causes a vocoder to inter-work with the CDMA-2000 modem 234, thereby enabling communication through the CDMA-2000 modem 234 (S520).

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

### INDUSTRIAL APPLICABILITY

According to the present invention as described above, a multimode-multiband terminal attempting handover omits a process including reception of an overhead message, a position information registration, etc., and monitors a handover-target cell, thereby reducing delay time required for searching for the target cell and improving the communication quality.

1. A method for searching for a target cell by using a multimode-multiband terminal in mobile communication environments, in which a mobile communication system improves a handover success rate and communication quality by reducing time required for searching for the target cell, the mobile communication system including a CDMA-2000 system and a WCDMA system, the CDMA-2000 system including a base-station transmission system and a base station controller and providing a CDMA-2000 service to a terminal requesting access, the WCDMA system including a Radio Transceiver Sub-system (RTS) and a Radio Network Controller (RNC) and providing a WCDMA service to the terminal requesting the access, the method comprising the steps of:
(a) receiving WCDMA signals transmitted from the WCDMA system through a WCDMA modem in order to measure an Energy of Carrier/Interference of Others (E_{c}/Iₒ) value;
(b) turning on a CDMA-2000 modem according to a result of step (a) and entering an idle state;
(c) monitoring a handover-target cell;
(d) transmitting a handover request to the WCDMA system;
(e) receiving a handover command from the WCDMA system; and
(f) turning off the WCDMA modem and switching a communication link to the CDMA-2000 system through the CDMA-2000 modem.

2. The method as claimed in claim 1, wherein the multimode-multiband terminal stores a target cell monitoring program, and switches the communication link through switching between the WCDMA modem and the CDMA-2000 modem when the multimode-multiband terminal moves to a different service area.

3. The method as claimed in claim 2, wherein the target cell monitoring program checks the E_{c}/Iₒ value, determines handover based on results obtained by checking the E_{c}/Iₒ value, and monitors the handover-target cell without performing a process for receiving an overhead message from the CDMA-2000 system or the WCDMA system and registering position information.

4. The method as claimed in claim 1, wherein, in step (a), the multimode-multiband terminal periodically searches for a Common Pilot Channel (CPICH) of the WCDMA system, and receives the WCDMA signals.

5. The method as claimed in claim 1, wherein, in step (a), the WCDMA modem measures the E_{c}/Iₒ value and generates an on-parameter for requesting an operation of the CDMA-2000 modem according to a measurement result obtained by measuring the E_{c}/Iₒ value.

6. The method as claimed in claim 5, wherein the measurement result includes a case in which the E_{c}/Iₒ value is continued while satisfying conditions required for turning on the CDMA-2000 modem.

7. The method as claimed in claim 1, wherein step (b) comprises the sub-steps of:
(b1) receiving an on-parameter from the WCDMA modem;
(b2) performing an initialization operation of the CDMA-2000 modem;
(b3) monitoring CDMA signals transmitted from the CDMA-2000 system and detecting a radio base station of a cell, which transmits the CDMA signals having high radio wave power, without performing reception of an overhead message and position information registration after the initialization operation is performed; and
(b4) generating a handover start parameter and transmitting the handover start parameter to the WCDMA system.

8. The method as claimed in claim 7, wherein, in step (b2), the initialization operation is performed via a system determination sub-state, a pilot channel acquisition sub-state and a synchronization channel acquisition sub-state.

9. The method as claimed in claim 1, wherein the idle state is continued until the handover command transmitted from the WCDMA system is received.

10. The method as claimed in claim 1, wherein, in step (f), a Handover Completion Message (HCM) for reporting completion of handover is generated and transmitted to the CDMA-2000 system, after synchronization with the CDMA-2000 system is completed.

11. The method as claimed in claim 1, wherein, in step (f), the multimode-multiband terminal switches an internal vocoder to the CDMA-2000 modem, thereby maintaining the communication link.

12. A multimode-multiband terminal for improving a handover success rate and communication quality by reducing time required for searching for a target cell in a mobile communication system, the mobile communication system including a CDMA-2000 system and a WCDMA system, the CDMA-2000 system including a base-station transmission system and a base station controller and providing a CDMA-2000 service to a terminal requesting access, the WCDMA system including a Radio Transceiver Sub-system (RTS) and a Radio Network Controller (RNC) and providing a WCDMA service to the terminal requesting the access, the multimode-multiband terminal comprising:
an antenna for transmitting/receiving Radio Frequency (RF) signals through an air interface;
an RF transmission/reception unit for transmitting/receiving and modulating/demodulating the RF signals;
a CDMA-2000 filter for extracting desired CDMA signals from the RF signals of a CDMA-2000 band from the RF transmission/reception unit;
a CDMA-2000 modem for performing a call processing for the CDMA signals according to protocols defined in a CDMA-2000 standard;
a WCDMA filter for extracting desired WCDMA signals from the RF signals of a WCDMA band from the RF transmission/reception unit;
a WCDMA modem for performing a call processing for the WCDMA signals according to protocols defined in a WCDMA standard;
a controller for selecting either a WCDMA mode or a CDMA-2000 mode and controlling the multimode-multiband terminal to operate in the selected mode; and
a program storage unit for storing a realtime processing Operating System (OS) and a target cell monitoring program.

13. The multimode-multiband terminal as claimed in claim 12, wherein the controller turns off the WCDMA modem while the CDMA-2000 modem operates, and turns off the CDMA-2000 modem while the WCDMA modem operates.

14. The multimode-multiband terminal as claimed in claim 12, wherein the target cell monitoring program receives pilot signals transmitted from the WCDMA system in order to check an Energy of Carrier/Interference of Others (E_{c}/Iₒ) value, and operates the CDMA-2000 modem based on results obtained by checking the E_{c}/Iₒ value, thereby performing handover.

15. The multimode-multiband terminal as claimed in claim 12, wherein the target cell monitoring program controls the multimode-multiband terminal to monitor a handover-target cell without performing a process for receiving an overhead message from the CDMA-2000 system or the WCDMA system and registering position information, after an initialization operation of the CDMA-2000 modem is performed.

16. The multimode-multiband terminal as claimed in claim 12, wherein the CDMA-2000 modem performs an initialization operation when the multimode-multiband terminal is handed over to the CDMA-2000 system, and the initialization operation is performed via a system determination sub-state, a pilot channel acquisition sub-state and a synchronization channel acquisition sub-state.

17. A mobile communication system for providing a multimode-multiband terminal with a CDMA-2000 service and a WCDMA service and improving a handover success rate and communication quality by reducing time required for searching for a target cell, the mobile communication system comprising:
a Radio Access Network (RAN) for providing the CDMA-2000 service through a traffic channel of signal channels, the RAN being disposed in each cell;
a WCDMA Radio Access Network (W-RAN) for providing the WCDMA service through the traffic channel of the signal channels, the W-RAN being disposed in each cell; and
a mobile communication switching center for performing functions of processing basic and supplementary services, processing subscriber's incoming and outgoing calls, processing position information registration and handover procedures, and inter-working with other networks.

18. The mobile communication system as claimed in claim 17, wherein the multimode-multiband terminal comprises:
an antenna for transmitting/receiving Radio Frequency (RF) signals through an air interface;
an RF transmission/reception unit for transmitting/receiving and modulating/demodulating the RF signals;
a CDMA-2000 filter for extracting desired CDMA signals from the RF signals of a CDMA-2000 band from the RF transmission/reception unit;
a CDMA-2000 modem for performing a call processing for the CDMA-2000 signals according to protocols defined in a CDMA-2000;
a WCDMA filter for extracting desired WCDMA signals from the RF signals of a WCDMA band from the RF transmission/reception unit;
a WCDMA modem for performing a call processing for the WCDMA signals according to protocols defined in a WCDMA;
a controller for selecting either a WCDMA mode or a CDMA-2000 mode and controlling the multimode-multiband terminal to operate in the selected mode; and
a program storage unit for storing a realtime processing Operating System (OS) and a target cell monitoring program.

19. The mobile communication system as claimed in claim 17, wherein the multimode-multiband terminal performs an initialization operation to the RAN when the multimode-multiband terminal detects the WCDMA signals transmitted from the W-RAN become weak.

20. The mobile communication system as claimed in claim 19, wherein the initialization operation is performed via a system determination sub-state, a pilot channel acquisition sub-state and a synchronization channel acquisition sub-state.

21. The mobile communication system as claimed in claim 17, wherein the multimode-multiband terminal monitors a handover-target cell in an idle state without performing a process for receiving an overhead message and registering position information, after an initialization operation is performed.

22. The mobile communication system as claimed in claim 17, wherein the target cell monitoring program receives pilot signals from the W-RAN in order to check an Energy of Carrier/Interference of Others (E_{c}/Iₒ) value, and operates the CDMA-2000 modem based on results obtained by checking the E_{c}/Iₒ value, thereby performing handover.

23. The mobile communication system as claimed in claim 18, wherein the target cell monitoring program controls the multimode-multiband terminal to monitor a handover-target cell without performing a process for receiving an overhead message and registering position information, after an initialization operation of the CDMA-2000 modem is performed.

24. The mobile communication system as claimed in claim 17, wherein the multimode-multiband terminal generates a Handover Completion Message (HCM) for reporting completion of handover and transmits the HCM to the RAN, after completing synchronization with the RAN.

25. The mobile communication system as claimed in claim 12, wherein the RTS performs a radio access termination function with a terminal conforming to a 3GPP radio access standard, generates a handover command, and transmits the handover command to a terminal attempting handover.

26. The mobile communication system as claimed in claim 18, wherein the multimode-multiband terminal performs an initialization operation to the RAN when the multimode-multiband terminal detects the WCDMA signals transmitted from the W-RAN become weak.

27. The mobile communication system as claimed in claim 18, wherein the target cell monitoring program receives pilot signals from the W-RAN in order to check an Energy of Carrier/Interference of Others (E_{c}/Iₒ) value, and operates the CDMA-2000 modem based on results obtained by checking the E_{c}/Iₒ value, thereby performing handover.

28. The mobile communication system as claimed in claim 18, wherein the multimode-multiband terminal generates a Handover Completion Message (HCM) for reporting completion of handover and transmits the HCM to the RAN, after completing synchronization with the RAN.
